(19) United States
(12) Patent Application Publication
(10) Pub. No.: US 2019/0074119 A1
(43) Pub. Date: Mar. 7, 2019

(54) DEFECT-IRRELEVANT HIGH TEMPERATURE SUPERCONDUCTOR (HTS) MAGNET

(71) Applicant: The Florida State University Research Foundation, Inc., Tallahassee, FL (US)

(72) Inventors: Seungyong Hahn, Tallahassee, FL (US); Kwang Lok Kim, Tallahassee, FL (US)

(21) Appl. No.: 16/180,797

(22) Filed: Nov. 5, 2018

Related U.S. Application Data
(63) Continuation of application No. PCT/US2017/031327, filed on May 5, 2017.
(60) Provisional application No. 62/332,152, filed on May 5, 2016.

(51) Int. Cl. H01F 6/06; H01F 41/04

(52) U.S. Cl. CPC H01F 6/06; H01F 41/048

(57) ABSTRACT

A superconducting coil, including at least one high-temperature superconducting (HTS) no-insulation (NI) conductor wound about a longitudinal axis to form a pancake coil, wherein the at least one HTS NI conductor comprises one or more defects.

### CROSS-REFERENCE TO RELATED APPLICATIONS

This application is a continuation of and claims priority to International Patent Application No. PCT/US2017/031327, entitled “DEFECT-IRRELEVANT HIGH TEMPERATURE SUPERCONDUCTOR (HTS) MAGNET”, filed May 5, 2017 by the same inventors, which claims priority to U.S. Provisional Patent Application No. 62/332,152, entitled “Defect Irrelevant Winding Technique for High Temperature Superconductor Magnet”, filed on May 5, 2016, the entirety of which is hereby incorporated by reference

### BACKGROUND OF THE INVENTION

Superconducting wire, such as REBCO (RE-Ba₂—Cu₃—Oₓ, RE: rare Earth) coated conductors, have been regarded as one of the most viable high-temperature superconductor (HTS) options for next-generation high field magnets, mainly owning to the large in-field current carrying capacity and mechanical robustness of the HTS wire. Commercial REBCO tapes show a 95% critical current (I_{c}) retention strain of 0.5% or higher, which corresponds to a tensile stress of 550-850 MPa, depending upon the tape's specific architecture. The latest REBCO tapes have carried 15 MA cm⁻² in a 2.2 μm thick REBCO film at 30 K under a 3 T c-axis parallel field. To date, multiple REBCO magnets have reached >20 T, including 35.4 T by a 4.4 T REBCO insert in a background field of 35 T; 27 T by a 12 T REBCO insert in 15 T; and 26 T by an all-REBCO magnet. These results demonstrate the strong potential of REBCO technology for next-generation high field (>20 T) user magnets.

Despite the technical progress in both conductors and coils, the use of REBCO technology has not been widespread. One of the serious impediments is the cost of the conductor and a major cost driver is the requirement that the REBCO tapes be provided as “defect-free” long piece lengths, which results in a low production yield.

Conventional high temperature superconductor (HTS) magnets have typically been constructed with a defect-free and continuous piece of superconducting wire or tape, such as REBCO tape, which is the primary cost driver for HTS magnets. In addition, in order to meet the “long” length requirements of the HTS wire, multiple “short” pieces of HTS wires may be spliced together by soldering. The soldering approach to forming a sufficient long-length wire inevitably results in multiple “bumps” in the HTS winding where the pieces are soldered together. These bumps are unfavorable, from the mechanical perspective, for high field magnets.

As such, an essentially defect-free and continuous piece of HTS wire has been regarded as indispensable for the construction of no-insulation (NI) HTS magnets. This requirement is very demanding of perfection in the HTS wire and is thus the primary cost driver for HTS magnets. In order to reduce cost and to manufacture mechanically more robust HTS magnets, it is desirable to use multiple short pieces of HTS wire rather than a single long piece to create the HTS winding. However, no such processes have yet been satisfactorily demonstrated.

Accordingly, what is needed is a method for manufacturing HTS windings using multiple pieces of HTS wire that addresses the high cost of using defect-free, long-length HTS wire or tape. However, in view of the art considered as a whole at the time the present invention was made, it was not obvious to those of ordinary skill in the field of this disclosure how the shortcomings of the prior art could be overcome.

### SUMMARY OF THE INVENTION

In various embodiments, the present invention provides a superconducting coil which is comprised of at least one high-temperature superconducting (HTS) no-insulation (NI) conductor, having one or more defects, wound about a longitudinal axis to form a pancake coil. The defects in the conductors are identified as locations within the HTS NI conductor in which a local critical current is less than about 80% of an average critical current of the HTS NI conductor.

In the HTS NI pancake coil formed by defective conductors, in accordance with the present invention, a portion of the coil current bypasses the defect spots and is shared with its neighboring turns. As a result, the coil can easily carry a nominal operating current, regardless of the defects in the conductor used to form the coil.

In an additional embodiment, the present invention provides a method for providing a superconducting coil which includes, winding at least one high-temperature superconducting (HTS) no-insulation (NI) conductor about a longitudinal axis to form a pancake coil, wherein the at least one HTS NI conductor comprises one or more defects.

As such, the present invention provides a superconducting coil that is fabricated of one or more superconductors that include one or more defects. The resulting superconducting coil and the associated method for manufacturing the superconducting coil addresses the high cost of using defect-free, long-length, superconducting wire or tape.

These and other important objects, advantages, and features of various embodiments will become clear as this disclosure proceeds.

The present disclosure accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 illustrates a superconducting HTS pancake coil, in accordance with an embodiment of the present invention.

FIG. 2 is a graphical illustration of the critical current (I_{c}) measurement of the HTS winding of FIG. 1, in accordance with an embodiment of the present invention.

FIG. 3 is a graphical illustration of an enlarged view of the critical current (I_{c}) measurement around the worst defect of the HTS winding of FIG. 1, in accordance with an embodiment of the present invention.

FIG. 4 is a graphical illustration of the charging test results up to 60 A for the HTS winding of FIG. 1, in accordance with an embodiment of the present invention.

FIG. 5 is a graphical illustration of the comparison between a calculated and measured axial field at the coil center of the HTS winding of FIG. 1, in accordance with an embodiment of the present invention.

FIG. 6 is a graphical illustration of the critical current (I_{c}) test results of the HTS winding of FIG. 1, in accordance with an embodiment of the present invention.

FIG. 7 is a graphical illustration of the voltage versus current (V-I) replotted from FIG. 6, in accordance with an embodiment of the present invention.

FIG. 8 is a graphical illustration of the angular dependencies of the critical current (I_{c}) of a short sample of REBCO that was used to wind the HTS winding of FIG. 1, in accordance with an embodiment of the present invention.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of various embodiments, Applicants in no way disclaim these technical aspects, and it is contemplated that the present disclosure may encompass one or more of the conventional technical aspects discussed herein.

The present disclosure may address one or more of the problems and deficiencies of the prior art discussed above. However, it is contemplated that various embodiments may prove useful in addressing other problems and deficiencies in a number of technical areas. Therefore, the present disclosure should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

Superconductors may be used to fabricate superconducting magnetic coils, such as solenoids, magnets, etc., in which the superconductors is wound into the shape of a coil. When the temperature of the wound coil is sufficiently low that the HTS conductor exists in a superconducting state, the current carrying ability and the magnitude of the resulting magnetic field is significantly increased. Typical superconducting materials include niobium-titanium, niobium-tin, copper oxide ceramics and members of the rare-earth-copper-oxide family. In the fabrication of superconducting coils, the superconductor may be formed into a wire or thin tape that is capable of being bend around the diameter of a core. Conventional methods for the manufacture of superconducting windings utilizes multiple pieces of defect-free superconducting wire, such as high-temperature superconducting (HTS) no-insulation (NI) wire, wherein the ends of the pieces of superconducting wire are coupled together, such as by soldering, to create one continuous length of defect-free superconducting wire. The coupled defect-free superconducting wires are then wound around a bobbin to create a superconducting winding, such as a pancake coil. As such, in a pancake winding, the superconducting wire or tape is wound one turn on top of a preceding turn, thereby forming a plane of turns that are perpendicular to the axis of the coil.

Based on this existing no-insulation (NI) HTS winding technique, various embodiments of the present invention may comprise techniques to construct HTS magnets with HTS wires having multiple defects. Various embodiments may also allow discontinuities in the HTS wire of the NI HTS winding (coil). Discontinuities may, for example, comprise a gap between two pieces of HTS wire within the HTS winding. The gap may be an open space or may be at least partially filled with a coupling material such as solder. Discontinuities (and other defects) may increase resistivity within the HTS coil. Thus, various embodiments may be effective in allowing a winding to be constructed with resistive splices, defects, and even complete discontinuities in a NI winding, which is generally considered unacceptable in the prior art. Additionally, various embodiments may be beneficial from a mechanical perspective particularly for high field magnets, and may result in substantial reduction of HTS magnet construction costs by allowing the use of defect-containing (lower cost) HTS wires and mechanically more robust HTS magnets compared to the prior art.

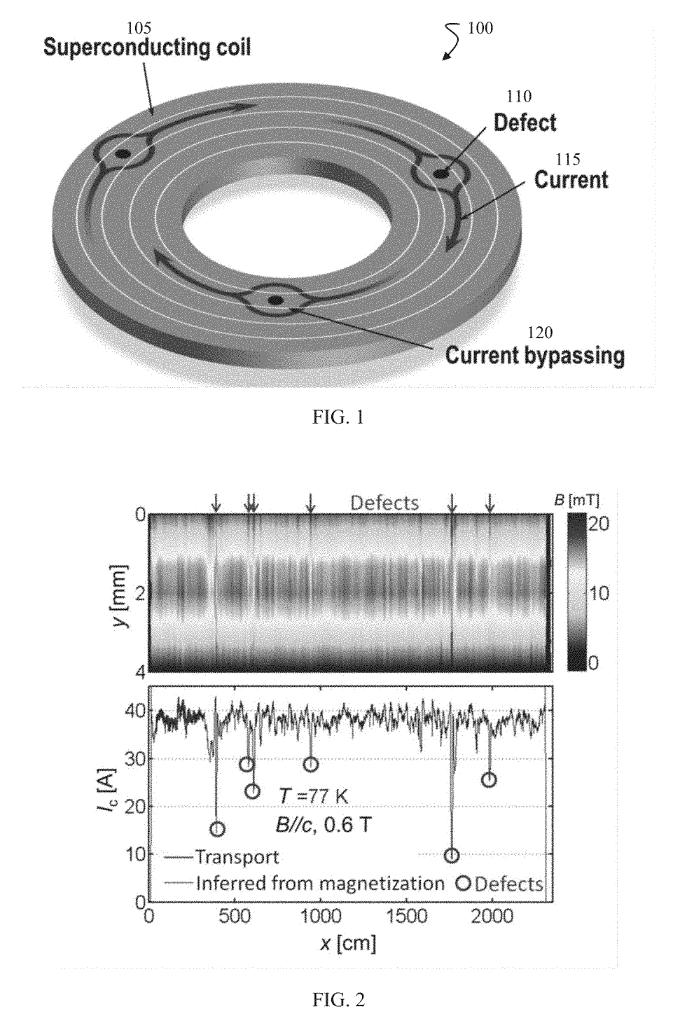

In various embodiments of the present invention, a no-insulation (NI) pancake coil is wound with one or more REBCO tapes, in spite of multiple defects existing in the tapes. In the present invention, a defect is defined as a local spot within a NI REBCO coil where the local critical current is substantially lower than the average critical current of the coil. With reference to FIG. 1, a defect-irrelevant winding (DIW) is presented, wherein a no-insulation (NI) pancake coil is wound with a REBCO tape containing multiple “defects”, at which local critical currents are substantially lower (<80%) than the tape's lengthwise average. In the NI pancake coil wound with defective REBCO tapes, a portion of the coil current bypasses the defect spots and is shared with its neighboring turns. As a result, the coil can easily carry a nominal operating current, regardless of the defects in the REBCO tape used to form the coil.

To verify the defect-irrelevant winding of the present invention, a no-insulation single pancake coil 100 was wound with one or more REBCO tapes 105 having multiple defects 110, as shown in FIG. 1. As shown, when a coil current 115 is induced in the NI pancake coil 100 wound with defective REBCO tapes 105, a portion of the coil current bypasses 120 the defect spots 110 and the coil current is shared with the neighboring coil turns. As a result, the coil can easily carry a nominal operating current, regardless of the defects in the REBCO tape used to form the coil.

Table 1 summarizes the key parameters of an exemplary test coil having an inner diameter of 40 mm and an outer diameter of 69.1 mm and a total of 135 turns wound from a 23 m long single piece of REBCO tape that was 4.1 mm wide and 0.1 mm thick. In this exemplary embodiment, a single piece of REBCO tape was used, however, it is within the scope of the invention to use more than on piece of REBCO tape to form the coil. When multiple pieces of REBCO tape are used, the ends of the REBCO tape may be abutted to each or may be positioned to overlap each other.

In the exemplary test coil, the field constant of the coil was calculated to be 3.18 mT/A at the coil center. The test coil exhibited an intrinsic charging delay due to the absence of turn-to-turn insulation and the charging time constant was measured to be 2.1 s, which corresponds to a characteristic resistance of 0.58 mΩ.

TABLE 1
Key parameters of the single pancake test coil.

| Parameters | | Values |
|---|---|---|
| REBCO tape width | [mm] | 4.0 |
| REBCO tape thickness | [mm] | 0.1 |
| Cu stabilizer thickness | [mm] | 0.04 |
| Inner diameter | [mm] | 40 |
| Outer diameter | [mm] | 69.1 |
| Height | [mm] | 4.1 |
| Total turns | | 135 |
| Measured critical current | [A] | 68.2 |
| Field constant at center | [mT/A] | 3.18 |
| Inductance | [mH] | 1.2 |
| Critical voltage (1 μV cm⁻¹ criterion) | [mV] | 2.3 |
| Characteristic resistance, R_{c} | [mΩ] | 0.58 |
| Charging time constant | [s] | 2.1 |

Prior to the construction of the text coil, the critical current (I_{c}) of the REBCO tape over the entire 23 m length of the tape was measured using a continuous I_{c} measurement device. The measurement device employed two approaches to measure the lengthwise variation of the conductor, I_{c}: (1) a magnetization method, with approximately 1 mm resolution, using a 0.5 T permanent magnet and a Hall sensor array; and (2) a transport current method with approximately 2 cm resolution, using an electromagnet that generates a c-axis parallel field up to 1 T.

FIG. 2 illustrates the continuous I_{c} measurement results for the test coil in which at least six major defects were identified. The defects are defined to be locations in the coil where the local critical current is <80% of the tape's average I_{c}, which in this exemplary embodiment is ˜38 A, at a 0.6 T c-axis parallel field.

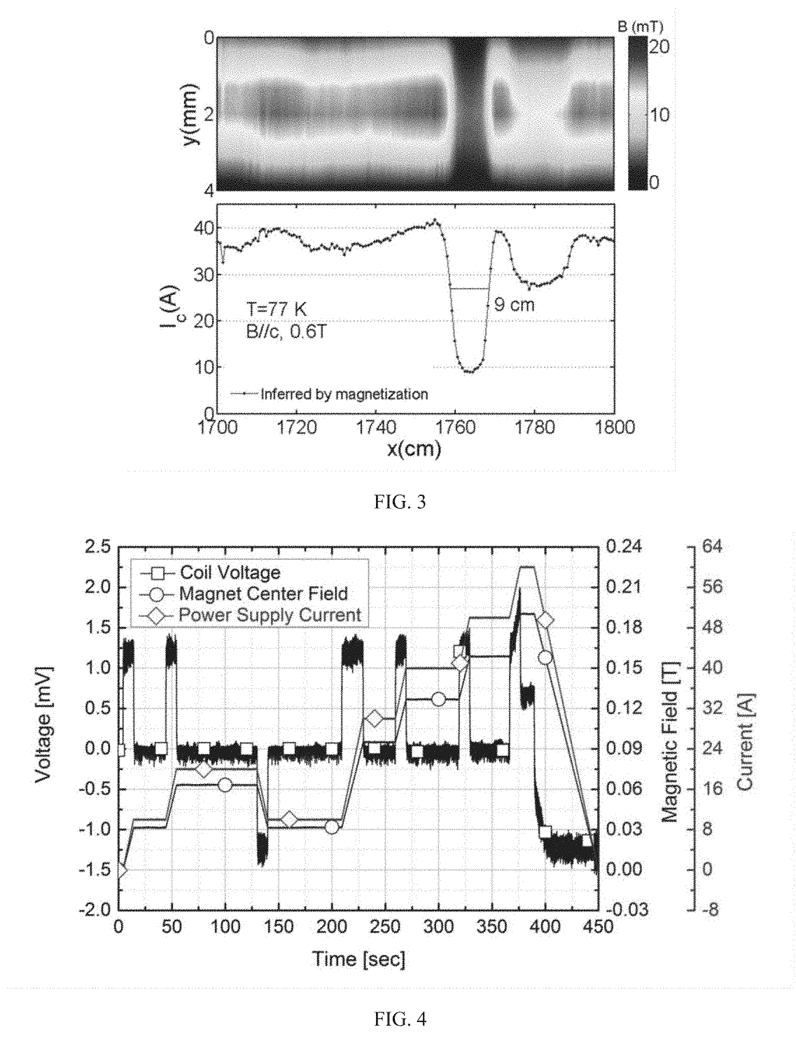

FIG. 3 illustrates an enlarged view of the length-wise I_{c} data around the worst defect in FIG. 2. As shown, the half-peak width in length was ˜9 cm, while those of the other five defects ranged from 6 cm to 11 cm, though they are not clearly shown in FIG. 2.

FIG. 4 illustrates the charging test results, up to 60 A. For this measurement, at every 10 A, the power supply current was held to monitor the steady-state behavior of the coil. While the current was increased, the ramping rate was maintained at 1 A s⁻¹. The coil terminal voltages in steady-state operations were shown to be negligible up to 50 A, while a voltage of 0.7 mV was measured at 60 A, which is smaller than the coil's critical voltage of 2.3 mV with a 1 μV cm⁻¹ criterion.

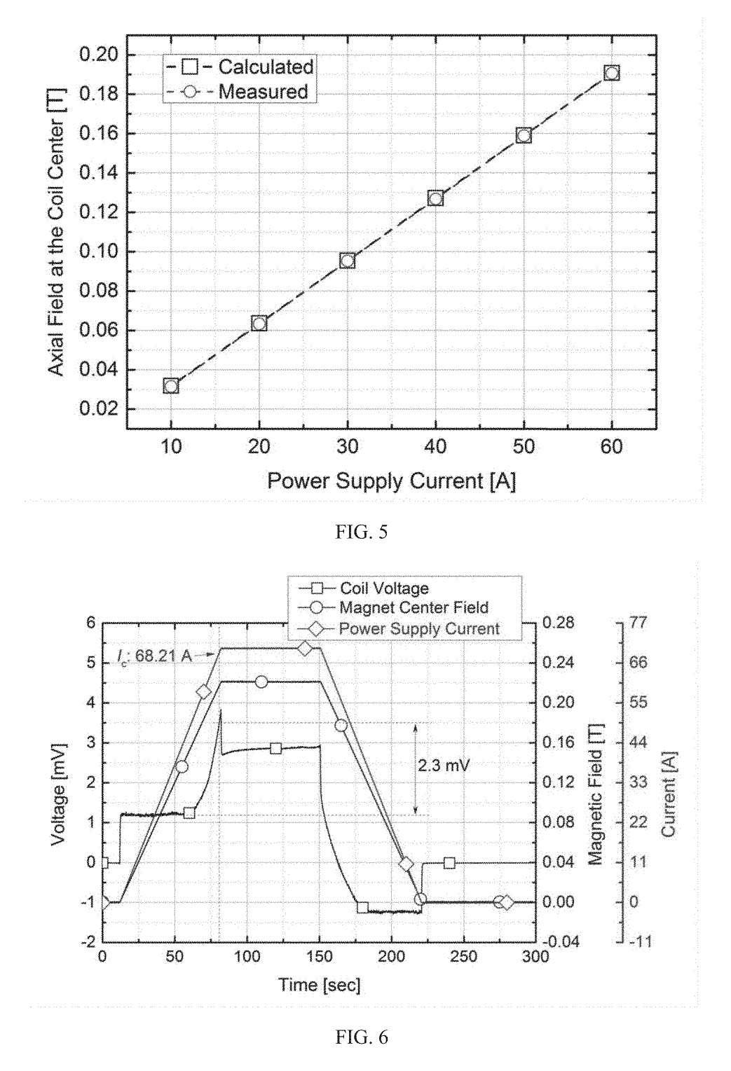

FIG. 5 illustrates a comparison of the calculated (squares) and the measured (circles) axial fields at the coil center. The discrepancy between the measured and calculated fields was less than 1%, i.e., beyond the Hall sensor resolution. The results imply that the impact of the defects on the coil center fields was negligible.

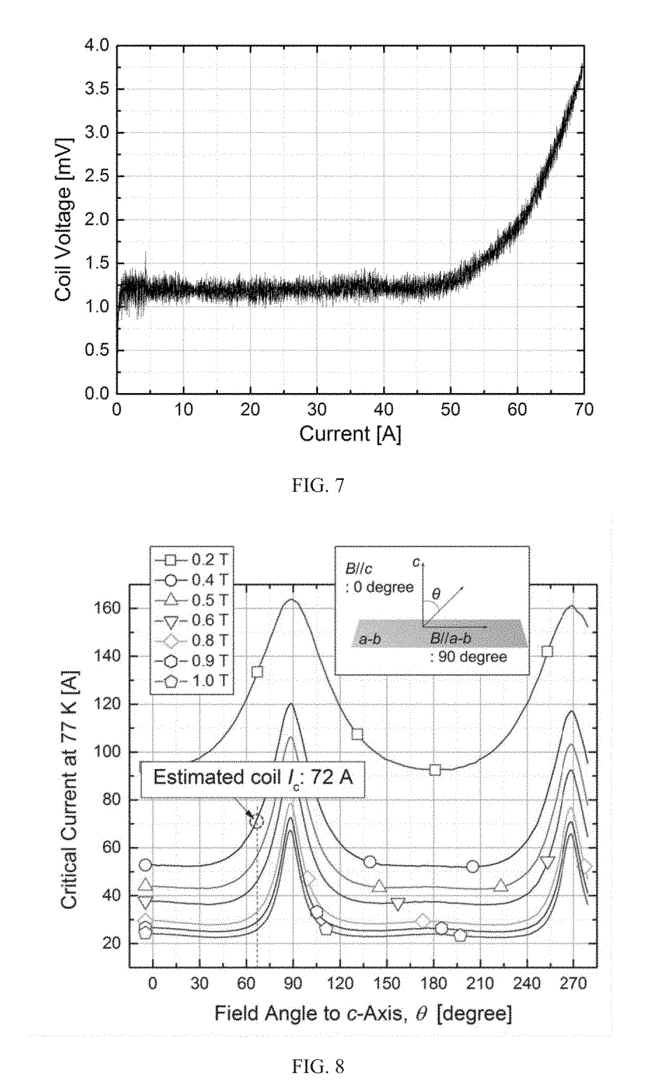

Following the charging test, the coil critical current (I_{c}) was measured to be 68 A by a transport I_{c} test up to 70 A, as shown in FIG. 6. FIG. 7 illustrates a voltage vs. current (V-I) graph replotted from the data in FIG. 6. The coil terminal voltage during the constant ramping (1 A s⁻¹) was measured to be 1.21 mV, which agrees well with the estimated value using the calculated coil inductance of 1.2 mH. To compare the measured I_{c} with that of its ideal “defect-free” counterpart, I_{c} angular dependencies of a leftover piece of the REBCO tape used to wind the test coil were measured, as shown in FIG. 8, and the critical current (I_{c}) of the individual turn within the coil was calculated by use of an in-house code based on the elliptic integral field analysis and the well-known load line approach. The critical current of the test coil was then estimated to be 72 A, close to the measured value of 68 A. It is well known that the I_{c} estimation of a REBCO pancake coil, from a short sample I_{c} angular dependency, is often inaccurate. However, the reasonable agreement between the measured and the calculated I_{c} may further justify the validity of the defect-irrelevant winding approach of the present invention.

Since the innermost turn perimeter of the test coil was 12.6 cm, which is shorter than the defect lengths of the coil, 6-11 cm, it follows that these lengths may have enabled the coil current to bypass the defect sections through “healthy” turn-to-turn contact between neighboring turns. This inherent current sharing at a local defect may be effective to enhance the operational reliability of an NI coil wound with REBCO tapes that are intrinsically single-strand.

The present invention provides an NI pancake coil wound with defective REBCO tapes that exhibits electromagnetic behaviors that are barely discernible from those of its ideal defect-free counterparts. When the inventive coil was operated below its critical current, the terminal voltages were negligible in stead-state operation, i.e., the coil was fully in a superconducting state. The impact of the defects on the field constant of the coil was also negligible, i.e., the measured field constant agreed well with the calculated field constant of its defect-free counterpart. The measured I_{c} of the defect coil (68 A) was close to the estimated I_{c} (72 A) based on the measured I_{c} angular dependencies of a defect-free short sample of REBCO tape.

The results demonstrate the potential of the defect-irrelevant winding technique of the present invention to build a pancake coil with REBCO tapes containing multiple defects, which may lead to a significant reduction in the construction cost of high-field NI REBCO magnets.

The advantages set forth above, and those made apparent from the foregoing description, are efficiently attained. Since certain changes may be made in the above construction without departing from the scope of the present disclosure, it is intended that all matters contained in the foregoing description or shown in the accompanying drawings shall be interpreted as illustrative and not in a limiting sense.

It is also to be understood that the following claims are intended to cover all of the generic and specific features of the disclosure herein described, and all statements of the scope of the disclosure that, as a matter of language, might be said to fall therebetween.

What is claimed is:

1. A superconducting coil, comprising:
at least one high-temperature superconducting (HTS) no-insulation (NI) conductor wound about a longitudinal axis to form a pancake coil, wherein the at least one HTS NI conductor comprises one or more defects.

2. The superconducting coil of claim 1, wherein the HTS NI conductor is a wire.

3. The superconducting coil of claim 1, wherein the HTS NI conductor is a tape.

4. The superconducting coil of claim 1, wherein the one or more defects of the HTS NI conductor are identified as locations within the HTS NI conductor in which a local critical current is less than about 80% of an average critical current of the HTS NI conductor.

5. The superconducting coil of claim 1, wherein a defect of the one or more defects is a discontinuity in the HTS NI conductor.

6. The superconducting coil of the claim 1, wherein the HTS NI conductor is a REBCO (RE-Ba₂—Cu₃—Oₓ, RE: rare Earth) conductor.

7. A superconducting coil, comprising:
at least one high-temperature superconducting (HTS) no-insulation (NI) conductor wound about a longitudinal axis to form a pancake coil, wherein the at least one HTS NI conductor comprises one or more defects and wherein the one or more defects are identified as locations within the HTS NI conductor in which a local critical current is less than about 80% of an average critical current of the HTS NI conductor.

8. The superconducting coil of claim 7, wherein the HTS NI conductor is a wire.

9. The superconducting coil of claim 7, wherein the HTS NI conductor is a tape.

10. The superconducting coil of claim 7, wherein a defect of the one or more defects is a discontinuity in the HTS NI conductor.

11. The superconducting coil of the claim 7, wherein the HTS NI conductor is a REBCO (RE-Ba₂—Cu₃—Oₓ, RE: rare Earth) conductor.

12. A method for providing a superconducting coil, the method comprising:
winding at least one high-temperature superconducting (HTS) no-insulation (NI) conductor about a longitudinal axis to form a pancake coil, wherein the at least one HTS NI conductor comprises one or more defects.

13. The method of claim 12, wherein the HTS NI conductor is a wire.

14. The method of claim 12, wherein the HTS NI conductor is a tape.

15. The method of claim 12, wherein the one or more defects of the HTS NI conductor are identified as locations within the HTS NI conductor in which a local critical current is less than about 80% of an average critical current of the HTS NI conductor.

16. The method of claim 12, wherein a defect of the one or more defects is a discontinuity in the HTS NI conductor.

17. The method of the claim 12, wherein the HTS NI conductor is a REBCO (RE-Ba₂—Cu₃—Oₓ, RE: rare Earth) conductor.
